(19) United States
(12) Patent Application Publication
(10) Pub. No.: US 2026/0277163 A1
(43) Pub. Date: Sep. 17, 2026

(54) TIMEPIECE, CONTROL METHOD FOR TIMEPIECE, AND CONTROL PROGRAM FOR TIMEPIECE

(71) Applicant: SEIKO WATCH KABUSHIKI KAISHA (trading as SEIKO WATCH CORPORATION), Tokyo (JP)

(72) Inventors: Akihito OKUMURA, Tokyo (JP); Satoshi SAKAI, Tokyo (JP); Tomohiro IHASHI, Tokyo (JP); Misaki UCHIYAMA, Tokyo (JP)

(21) Appl. No.: 19/544,727

(22) Filed: Feb. 19, 2026

(30) Foreign Application Priority Data
Mar. 14, 2025 (JP) 2025-041893

(51) Int. Cl. G04C 3/14

(52) U.S. Cl. CPC G04C 3/14

(57) ABSTRACT

A timepiece that achieves low current consumption is provided. The timepiece includes: a battery; a time display function; a measurement display function different from the time display function; a first motor configured to operate with the electric power of the battery, the first motor corresponding to the time display function; a second motor configured to operate with the electric power of the battery, the second motor corresponding to the measurement display function; and a control unit configured to control operations of the first motor and the second motor, in which the control unit, when the time display function and the measurement display function are both in operation, causes the first motor to operate in a fixed pulse method of outputting a predetermined pulse in a hand movement cycle of 1 Hz, causes the second motor to operate in the correction drive method in a hand movement cycle shorter than 1 Hz, and adjusts an output timing so that timings of pulse for driving the first motor and the second motor do not overlap.

### RELATED APPLICATIONS

This application claims priority to Japanese Patent application No. JP2025-041893 filed on Mar. 14, 2025, the entire content of which is incorporated herein by reference.

### BACKGROUND OF THE INVENTION

### 1. Field of the Invention

The present disclosure relates to a timepiece, a control method for a timepiece, and a control program for a timepiece.

### 2. Description of the Related Art

In a timepiece including a time motor and a stopwatch motor and capable of performing a time display and stopwatch measurement at the same time, there is a technique of controlling pulse output timings of the two motors so as not to overlap each other by operating the time motor in a correction drive method and operating the stopwatch motor in a fixed pulse method in which the stopwatch motor is driven by a predetermined pulse (see PTL 1). In the stopwatch measurement, measurement may be performed with high resolution by moving a hand at a speed faster than 1 Hz. Since a start timing of the stopwatch measurement is determined by a timing at which a user presses a button, a voltage significantly drops due to an operation load of the motor unless timings of pulse are controlled so as not to overlap. Therefore, when driving the stopwatch motor, the fixed pulse method, which requires a short time for a pulse output, makes it easier to perform control to avoid overlapping of the pulse output timings of the two motors.

Here, as disclosed in PTL 2, a correction drive method is a drive method in which, when a motor is driven by a main drive pulse, a detection signal is detected based on an induced voltage generated in the motor, rotation is determined, and according to a determination result, a drive pulse is changed to a main drive pulse having a different pulse width, and drive is performed, or the motor is forcibly rotated by a correction drive pulse having a pulse width larger than that of the main drive pulse. Since a time motor is driven by an optimum main drive pulse by the correction drive method, current consumption of the motor is reduced.

### 3. Citations

### Patent Literature

PTL 1: JP2011-169750A

PTL 2: JPS61-15385B

### SUMMARY OF THE INVENTION

To further reduce the current consumption of the timepiece, it is desirable to set drive of the stopwatch motor to correction drive. For example, as in the related art, when the timepiece motor is set to correction drive and the stopwatch motor is set to the fixed pulse method, in a case where the stopwatch motor is used for frequent stopwatch measurements, the stopwatch motor is always driven by a predetermined pulse, and thus current consumption increases, and a battery life of the timepiece significantly decreases.

The present disclosure has been made in view of the above points, and an object of the present disclosure is to provide a timepiece, a control method for a timepiece, and a control program for a timepiece that achieve low current consumption without causing a voltage drop due to overlapping of a pulse output of a time motor and a pulse output of a stopwatch motor in a timepiece capable of simultaneously performing a time display and stopwatch measurement.

According to an aspect of the present disclosure, a timepiece is provided. The timepiece includes: a battery; a time display function; a measurement display function different from the time display function; a first motor configured to operate with the electric power of the battery, the first motor corresponding to the time display function; a second motor configured to operate with the electric power of the battery, the second motor corresponding to the measurement display function; and a control unit configured to control operations of the first motor and the second motor. The control unit, when the measurement display function is not in operation, causes the first motor to operate in a correction drive method of outputting a correction drive pulse for driving the motor in accordance with determination of presence or absence of rotation of the motor in a hand movement cycle of 1 Hz, and when the time display function and the measurement display function are both in operation, causes the first motor to operate in a fixed pulse method of outputting a predetermined pulse in the hand movement cycle of 1 Hz, causes the second motor to operate in the correction drive method in a hand movement cycle shorter than 1 Hz, and adjusts an output timing so that timings of pulse for driving the first motor and the second motor do not overlap.

In a case where a hand movement timing of the time display function is in a period for outputting the correction drive pulse in the correction drive method, when determining that the second motor is rotating, the control unit may wait for an output of a pulse in the fixed pulse method until a rotation detection flag of the second motor is set.

In a case where a hand movement timing of the time display function is in a period for outputting the correction drive pulse in the correction drive method, when determining that the second motor is not rotating, the control unit may wait for an output of a pulse in the fixed pulse method until the period ends.

When a hand movement timing of the time display function is in a period for outputting the correction drive pulse in the correction drive method, the control unit may wait for start of the period for outputting the correction drive pulse until an output of a pulse in the fixed pulse method is completed.

The control unit may detect a voltage of the battery while avoiding a period in which the correction drive pulse is output.

According to another aspect of the present disclosure, a control method for a timepiece is provided. The control method for a timepiece including a battery, a time display function, a measurement display function different from the time display function, a first motor configured to operate with the electric power of the battery, the first motor corresponding to the time display function, and a second motor configured to operate with the electric power of the battery, the second motor corresponding to the measurement display function, includes: by a processor, when the measurement display function is not in operation, causing the first motor to operate in a correction drive method of outputting a correction drive pulse for driving the motor in accordance with determination of presence or absence of rotation of the motor in a hand movement cycle of 1 Hz; and when the time display function and the measurement display function are both in operation, causing the first motor to operate in a fixed pulse method of outputting a predetermined pulse in the hand movement cycle of 1 Hz, causing the second motor to operate in the correction drive method in a hand movement cycle shorter than 1 Hz, and adjusting an output timing so that timings of pulse for driving the first motor and the second motor do not overlap.

According to another aspect of the present disclosure, a control program for a timepiece is provided. The control program for a timepiece including a battery, a time display function, a measurement display function different from the time display function, a first motor configured to operate with the electric power of the battery, the first motor corresponding to the time display function, and a second motor configured to operate with the electric power of the battery, the second motor corresponding to the measurement display function, causes a computer to execute processing of: when the measurement display function is not in operation, causing the first motor to operate in a correction drive method of outputting a correction drive pulse for driving the motor in accordance with determination of presence or absence of rotation of the motor in a hand movement cycle of 1 Hz; and when the time display function and the measurement display function are both in operation, causing the first motor to operate in a fixed pulse method of outputting a predetermined pulse in the hand movement cycle of 1 Hz, causing the second motor to operate in the correction drive method in a hand movement cycle shorter than 1 Hz, and adjusting an output timing so that timings of pulse for driving the first motor and the second motor do not overlap.

According to the present disclosure, it is possible to provide a timepiece, a control method for a timepiece, and a control program for a timepiece that achieve low current consumption without causing a voltage drop due to overlapping of a pulse output of a time motor and a pulse output of a stopwatch motor in a timepiece capable of simultaneously performing a time display and stopwatch measurement.

### BRIEF DESCRIPTION OF THE DRAWINGS

FIG. 1 is a block diagram illustrating a functional configuration example of a timepiece according to an embodiment of the disclosed technology.

FIG. 2 is a diagram illustrating an arrangement example of a 1/100 seconds hand, a 1/10 seconds hand, a seconds hand, a minute hand, and an hour hand of the timepiece according to the same embodiment.

FIG. 3 is a timing chart illustrating a pulse output timing.

FIG. 4 is a timing chart illustrating a pulse output timing.

FIG. 5 is a timing chart illustrating a pulse output timing.

FIG. 6 is a timing chart illustrating a pulse output timing.

FIG. 7 is a timing chart illustrating a pulse output timing.

FIG. 8 is a timing chart illustrating a pulse output timing.

FIG. 9 is a timing chart illustrating a pulse output timing.

FIG. 10 is a flowchart illustrating a flow of control processing of the timepiece executed by a control unit.

FIG. 11 is a flowchart illustrating a flow of control processing of the timepiece executed by the control unit.

FIG. 12 is a graph illustrating an effect of the present embodiment.

FIG. 13 is a table illustrating the effect of the present embodiment.

### DETAILED DESCRIPTION OF THE PREFERRED EMBODIMENTS

Hereinafter, an example of an embodiment of the present disclosure will be described with reference to the drawings. In the drawings, the same or equivalent components and portions are denoted by the same reference numerals. In addition, dimensional ratios in the drawings are exaggerated for convenience of description and may be different from actual ratios.

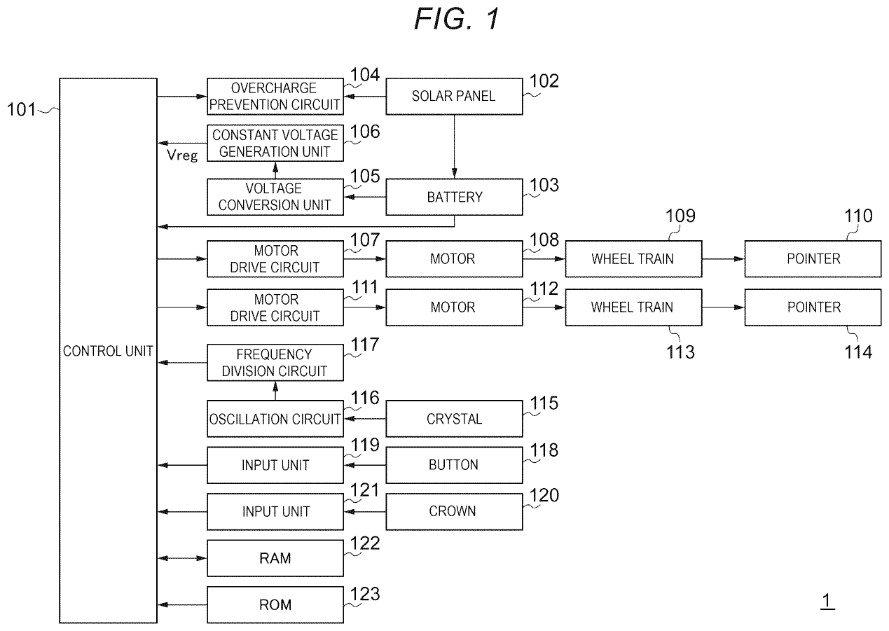

FIG. 1 is a block diagram illustrating a functional configuration example of a timepiece 1 according to the present embodiment. The timepiece 1 according to the present embodiment includes a control unit 101, a solar panel 102, a battery 103, an overcharge prevention circuit 104, a voltage conversion unit 105, a constant voltage generation unit 106, a motor drive circuit 107, 111, a motor 108, 112, a wheel train 109, 113, a pointer 110, 114, a crystal 115, an oscillation circuit 116, a frequency division circuit 117, a button 118, a crown 120, an input unit 119, 121, a random access memory (RAM) 122, and a read only memory (ROM) 123. The timepiece 1 has a time display function of displaying time and a measurement display function of displaying measurement time of a stopwatch separately from the time display function.

The control unit 101 is a control circuit including a microprocessor, a microcontroller, and the like that controls the entire timepiece 1. Specifically, the control unit 101 integrally executes various types of processing such as calculation of time information, monitoring of a power supply state from the solar panel 102 or the like, output of a drive signal to the motor drive circuit 107, 111, and detection of inputs from the input unit 119, 121.

The solar panel 102 is a power generator that converts external light (sunlight, indoor light, etc.) into electrical energy. In the present embodiment, the solar panel 102 is used to replenish and supply electric power necessary for driving the timepiece 1. The solar panel 102 is disposed below a dial (not illustrated) of the timepiece 1 so that external light transmitted through the dial can be efficiently used for power generation. Specifically, the dial may be formed of a highly transparent or translucent material (for example, resin or thin glass), and the solar panel 102 may be disposed directly below the dial. A part or the whole of the dial may be formed in a ring shape, and the solar panel 102 may be disposed near an outer periphery of the dial so that external light is taken in from a ring portion.

The battery 103 is a secondary battery (rechargeable battery) that stores electric power generated by the solar panel 102 and functions as a power source for the entire timepiece 1. As the battery 103, for example, a lithium-ion secondary battery or a nickel-metal hydride battery can be used.

The overcharge prevention circuit 104 is a protection circuit that monitors a state of charge of the battery 103 and prevents the battery 103 from being excessively charged. The overcharge prevention circuit 104 includes a predetermined voltage control unit and a current control unit, and contributes to extending a life of the battery 103 and ensuring safety.

The voltage conversion unit 105 is a converter circuit that converts a voltage of the electric power supplied from the battery 103 into a voltage level at which the control unit 101 and other circuits can operate stably. The voltage conversion unit 105 may have either a step-up function or a step-down function.

The constant voltage generation unit 106 is a regulator circuit that stabilizes the electric power supplied from the voltage conversion unit 105 and provides a constant reference voltage Vreg for operation to circuits such as the control unit 101, the motor drive circuit 107, 111, the oscillation circuit 116, and the frequency division circuit 117.

The motor drive circuit 107 is a circuit for applying a drive pulse to the motor 108 based on a signal from the control unit 101 to rotate the pointer 110. The motor drive circuit 107 is a circuit that generates a drive pulse corresponding to a stepping motor.

The motor 108 is an example of a first motor in the present disclosure, and is a motor for rotating the pointer 110. The motor 108 is a small electric motor such as a stepping motor, and drives the pointer 110 at a predetermined speed and angle via the wheel train 109 upon receiving a command from the control unit 101.

The wheel train 109 includes a plurality of gears, and is a gear train (gear mechanism) for transmitting the rotation of the motor 108 to the pointer 110. The wheel train 109 accurately controls a rotation speed of the pointer 110 such as time, minute, and second by providing each gear with a predetermined reduction ratio.

The pointers 110 are hands (for example, a 24-hour display hand, an hour hand, a minute hand, and a seconds hand) for visually displaying time of the time display function. The pointer 110 rotates via the motor 108 and the wheel train 109 so that a user can easily read the time.

The motor drive circuit 111 is a circuit for applying a drive pulse to the motor 112 based on a signal from the control unit 101 to rotate the pointer 114. Similarly to the motor drive circuit 107, the motor drive circuit 111 is a circuit that generates a drive pulse corresponding to a stepping motor.

The motor 112 is an example of a second motor in the present disclosure, and is a motor for rotating the pointer 114. The motor 112 is a small electric motor such as a stepping motor, and drives the pointer 114 at a predetermined speed and angle via the wheel train 113 upon receiving a command from the control unit 101.

The wheel train 113 includes a plurality of gears, and is a gear train for transmitting the rotation of the motor 112 to the pointer 114. The wheel train 113 accurately controls a rotation speed of the pointer 114 such as time, minute, and second by providing each gear with a predetermined reduction ratio.

The pointer 114 is a hand (for example, a stopwatch 1/5 seconds hand or a stopwatch minute hand) for visually displaying measurement time of the measurement display function. The pointer 114 rotates via the motor 112 and the wheel train 113 so that the user can easily read the measurement time.

The crystal 115 is a crystal oscillator that oscillates at a predetermined resonance frequency, and functions as a reference vibration source of the timepiece 1. A crystal oscillator that oscillates at a frequency of, for example, 32,768 Hz is used as the crystal 115.

The oscillation circuit 116 is a circuit that generates a stable reference signal using the crystal 115. When the crystal oscillator is used as the crystal 115, the oscillation circuit 116 amplifies and stabilizes a resonance frequency of the crystal oscillator and obtains a highly accurate clock signal to be input to the frequency division circuit 117.

The frequency division circuit 117 divides the reference signal from the oscillation circuit 116 into predetermined frequencies, and converts the divided signals into a periodic signal that can be easily used by the control unit 101. The frequency division circuit 117 has, for example, a configuration of dividing a signal of 32,768 Hz generated by the oscillation circuit 116 into 1 Hz (1 second cycle).

The button 118 is an example of an input unit for performing switching of various modes, time setting, and the like by a user operation. The button 118 may include a single button or a plurality of buttons, and may be configured to assign different functions. The crown 120 is an operation unit for performing time adjustment and function setting by a rotation operation of a user or the like. The input unit 119 may include an interface circuit or a switch group that detects a user operation on the button 118 and notifies the control unit 101. The input unit 121 may include an interface circuit or a switch group that detects a user operation on the crown 120 and notifies the control unit 101.

The RAM 122 is a volatile memory for temporarily storing programs and various types of data for an operation of the timepiece 1. The RAM 122 is used to temporarily hold time information and store parameters according to an operation mode. The ROM 123 is a nonvolatile memory that stores a program for controlling the timepiece 1, a basic operation routine, various tables, and the like. The programs and the like recorded in the ROM 123 are referred to by the control unit 101 when the timepiece 1 is activated or when various modes are switched. In the present embodiment, the ROM 123 stores a control program for controlling the operation of the timepiece 1.

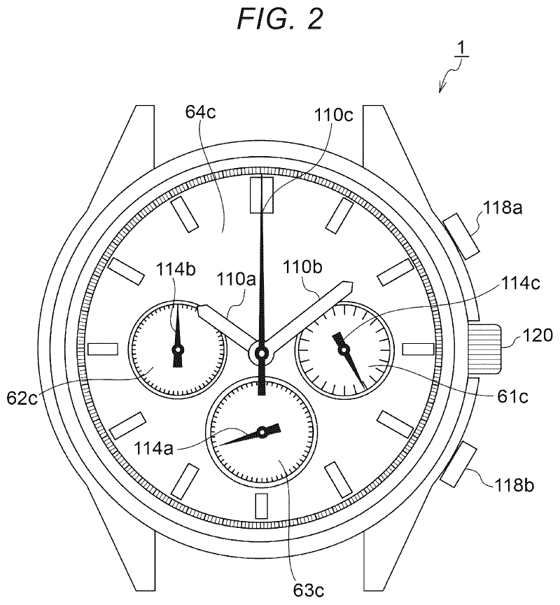

FIG. 2 is a diagram illustrating an arrangement example of a stopwatch 1/5 seconds hand, a stopwatch minute hand, a seconds hand, a minute hand, an hour hand, and a 24-hour display hand of the timepiece 1 according to the present embodiment. An example of the arrangement of an hour hand 110a, a minute hand 110b, a stopwatch 1/5 seconds hand 110c, a seconds hand 114a, a stopwatch minute hand 114b, and a 24-hour display hand 114c will be described with reference to the drawing.

As illustrated in FIG. 2, the timepiece 1 includes buttons 118a and 118b as the buttons 118. The button 118a is used for START, STOP, and the like when the measurement display function is used. The button 118b is used for RESET or the like when the measurement display function is used. The crown 120 is used for adjustment such as time adjustment. The buttons 118a and 118b and the crown 120 may be used for various inputs in each operation mode.

The timepiece 1 includes the hour hand 110a, the minute hand 110b, and the stopwatch 1/5 seconds hand 110c as the pointer 110, and includes the seconds hand 114a, the stopwatch minute hand 114b, and the 24-hour display hand 114c as the pointer 114.

The hour hand 110a, the minute hand 110b, the seconds hand 114a, and the 24-hour display hand 114c are driven at the time of a time display of the time display function, and perform the time display using scales displayed on an outer periphery of a first dial 61c, a third dial 63c, and a fourth dial 64c. The stopwatch minute hand 114b and the stopwatch 1/5 seconds hand 110c are driven when displaying measurement time of the measurement display function, and perform a stopwatch measurement time display using scales displayed on an outer periphery of a second dial 62c and the fourth dial 64c. A scale in units of one hour is displayed on the outer periphery of the first dial 61c, and a current hour in the 24-hour display is displayed by the 24-hour display hand 114c. A scale in units of one minute is displayed on the outer periphery of the second dial 62c, and a measurement result in units of one minute is displayed by the stopwatch minute hand 114b. A scale in units of one second is displayed on the outer periphery of the third dial 63c, and a current second is displayed by the seconds hand 114a.

Next, an example of driving control of the motors 108 and 112 by the control unit 101 will be described. The control unit 101 performs control to avoid overlapping of a pulse output of the motor 108 and a pulse output of the motor 112 to perform correction drive on the motor 112 for the purpose of reducing current consumption. The control unit 101 mainly controls the pulse output in the following four patterns.
(1) When a time hand movement timing is outside a motor frame of the motor 112 (as described later, a series of processing sections in a correction drive method)
(2) In the motor frame of the motor 112, when the time hand movement timing is in a magnetic field detection section, a noise detection section, and a main drive pulse output and rotation detection section
(3) In the motor frame of the motor 112, when the time hand movement timing is in a correction pulse output section
(4) When a time hand movement timing is immediately before the motor frame of the motor 112, and a time hand movement is performed

The control unit 101 can avoid the overlapping of the pulse output of the motor 108 and the pulse output of the motor 112 by controlling the pulse output according to each of the patterns (1) to (4) described above. Here, the motor frame refers to a series of processing sections in the correction drive method, specifically, a section obtained by combining the magnetic field detection section, the noise detection section, the main drive pulse output and rotation detection section, and a correction drive pulse output section. For example, when each section is 31.25 ms, the motor frame is about 125 ms.

In the following description, an operation example in which the stopwatch measurement is performed at 5 Hz and the time display and the stopwatch measurement are simultaneously performed is illustrated.
(1) When the time hand movement timing is outside the motor frame of the motor 112

When the time hand movement timing is outside the motor frame of the motor 112, the control unit 101 outputs a fixed pulse to the motor 108 at a 1 Hz timing without adjusting the timing.

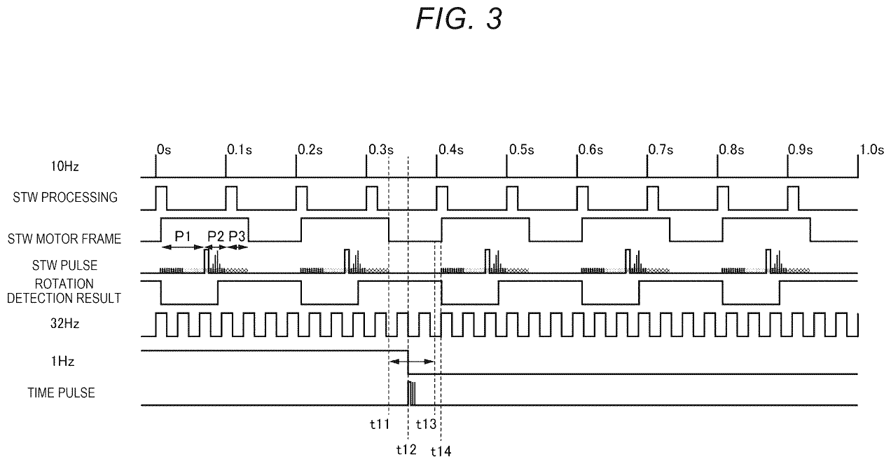

FIG. 3 is a timing chart illustrating a pulse output timing. The timing chart in FIG. 3 illustrates a 10 Hz timing measured internally to control the 5 Hz stopwatch measurement, a stopwatch (STW) processing time, the motor frame, a rotation detection result of the motor 112, a pulse output at 32 Hz, a pulse output at 1 Hz, and a time pulse for rotating the motor 108. The motor frame includes a magnetic field detection section and a noise detection section P1, a main drive pulse output and rotation detection section P2, and a correction pulse output section P3.

At time t11 in the timing chart in FIG. 3, the motor frame of the motor 112 ends, and at time t12 between time t11 and time t14 when the next motor frame of the motor 112 starts, the pulse output at 1 Hz changes from high to low. In this case, the control unit 101 outputs a fixed pulse to the motor 108 at a 1 Hz timing without adjusting the timing. When the pulse output at 1 Hz between times t11 and t13 changes from high to low, the control unit 101 outputs a fixed pulse to the motor 108 at a 1 Hz timing without adjusting the timing. (2) In the motor frame of the motor 112, when the time hand movement timing is in the magnetic field detection section, the noise detection section, and the main drive pulse output and rotation detection section

In the motor frame of the motor 112, when the time hand movement timing is in the magnetic field detection section, the noise detection section, and the main drive pulse output and rotation detection section, the control unit 101 further changes and adjusts the timing according to the rotation detection result of the motor 112.
(2-1) When the rotation detection result of the motor 112 is determined to be “rotation”

In the motor frame of the motor 112, when the time hand movement timing is in the magnetic field detection section, the noise detection section, the main drive pulse output and the rotation detection section, and the rotation detection result of the motor 112 is determined to be “rotation”, the control unit 101 checks the rotation detection result at a cycle of 32 Hz until the rotation detection result becomes high, and when the rotation detection result becomes high, outputs a fixed pulse for the motor 108.

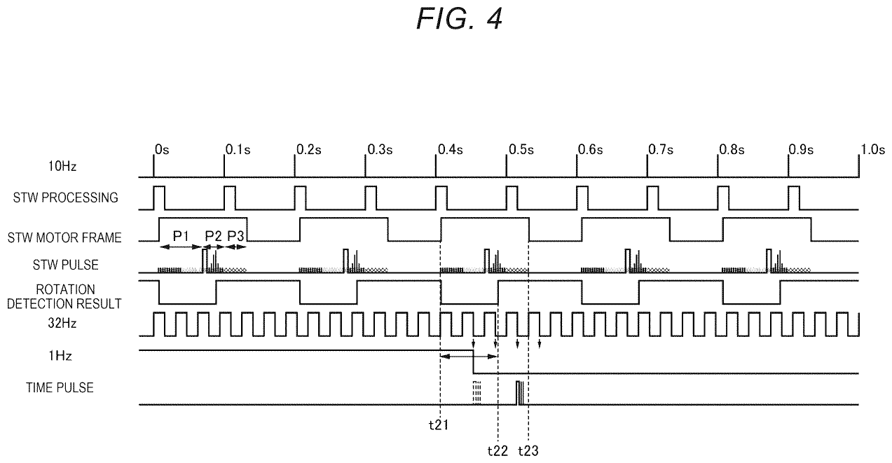

FIG. 4 is a timing chart illustrating a pulse output timing when the time hand movement timing is in the magnetic field detection section, the noise detection section, and the main drive pulse output and the rotation detection section in the motor frame of the motor 112 and a rotation detection result of the motor 112 is determined to be “rotation”. At time t21 in the timing chart in FIG. 4, the motor frame of the motor 112 starts, and between time t21 and time t23 when the motor frame of the motor 112 ends, the pulse output at 1 Hz changes from high to low. In this case, the control unit 101 checks in the cycle of 32 Hz until the rotation detection result becomes high, and outputs a fixed pulse for the motor 108 at a first confirmation timing after time t22 when the rotation detection result becomes high.
(2-2) When the rotation detection result of the motor 112 is determined to be “non-rotation”

In the motor frame of the motor 112, when the time hand movement timing is in the magnetic field detection section, the noise detection section, the main drive pulse output and the rotation detection section, and the rotation detection result of the motor 112 is determined to be “non-rotation”, since the rotation detection result of the motor 112 is not switched to high, the control unit 101 checks in a 32 Hz cycle until the motor frame ends, and outputs a fixed pulse for the motor 108 when the motor frame ends.

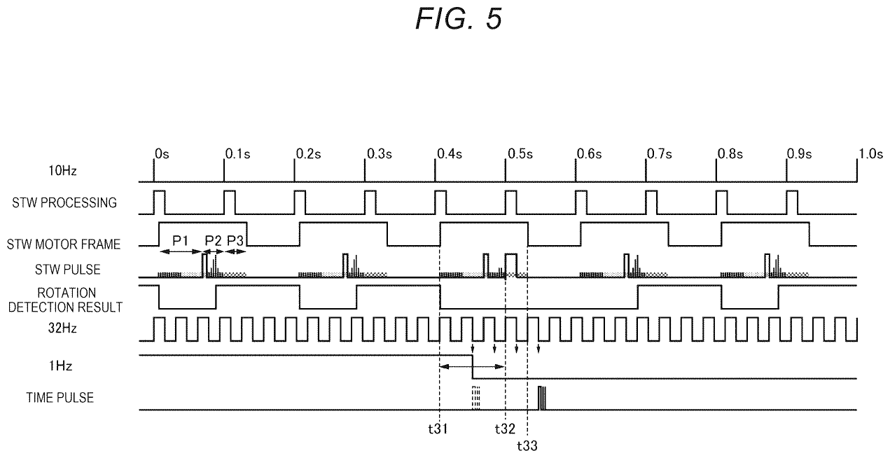

FIG. 5 is a timing chart illustrating a pulse output timing when the time hand movement timing is in the magnetic field detection section, the noise detection section, and the main drive pulse output and the rotation detection section in the motor frame of the motor 112 and a rotation detection result of the motor 112 is determined to be “non-rotation”. At time t31 in the timing chart in FIG. 5, the motor frame of the motor 112 starts, and between time t31 and time t33 when the motor frame of the motor 112 ends, the pulse output at 1 Hz changes from high to low. In this case, the rotation detection result remains low from time t31 to time t33. Therefore, the control unit 101 checks in a 32 Hz cycle until time t33 when the motor frame ends, and outputs a fixed pulse for the motor 108 at a confirmation timing of a first 32 Hz cycle after time t33 when the motor frame ends.
(3) In the motor frame of the motor 112, when the time hand movement timing is in the correction pulse output section

In the motor frame of the motor 112, when the time hand movement timing is in the correction pulse output section, the control unit 101 further changes and adjusts the timing according to the rotation detection result of the motor 112.
(3-1) When the rotation detection result of the motor 112 is determined to be “rotation”

In the motor frame of the motor 112, when the time hand movement timing is in the correction pulse output section and the rotation detection result of the motor 112 is determined to be “rotation”, the control unit 101 checks the rotation detection result at a cycle of 32 Hz until the rotation detection result becomes high, and when the rotation detection result becomes high, outputs a fixed pulse for the motor 108.

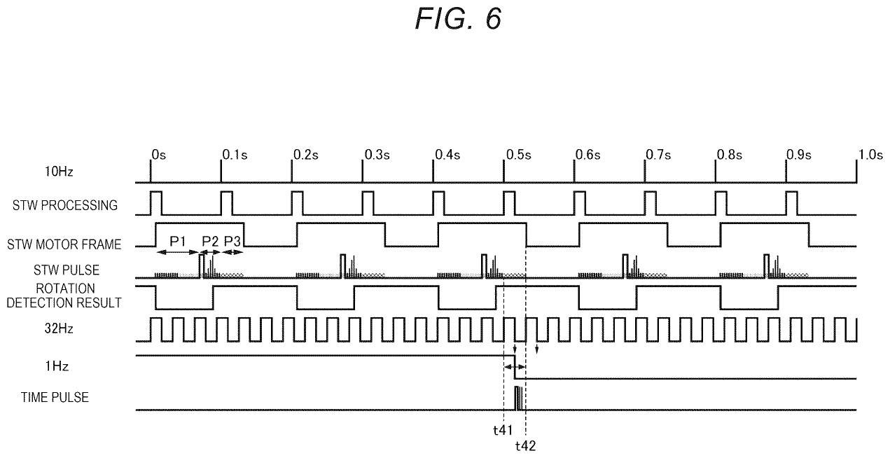

FIG. 6 is a timing chart illustrating a pulse output timing when the time hand movement timing is in the correction pulse output section in the motor frame of the motor 112 and a rotation detection result of the motor 112 is determined to be “rotation”. At time t41 in the timing chart in FIG. 6, the correction pulse output section P3 starts, and between time t41 and time t42 when the correction pulse output section P3 ends, the pulse output at 1 Hz changes from high to low. In this case, the control unit 101 checks in a cycle of 32 Hz until the rotation detection result becomes high, and outputs a fixed pulse for the motor 108 at a timing when it is confirmed that the rotation detection result becomes high.
(3-2) When the rotation detection result of the motor 112 is determined to be “non-rotation”

In the motor frame of the motor 112, when the time hand movement timing is in the correction pulse output section and the rotation detection result of the motor 112 is determined to be “non-rotation”, since the rotation detection result of the motor 112 is not switched to high, the control unit 101 checks in a 32 Hz cycle until the motor frame ends, and outputs a fixed pulse for the motor 108 when the motor frame ends.

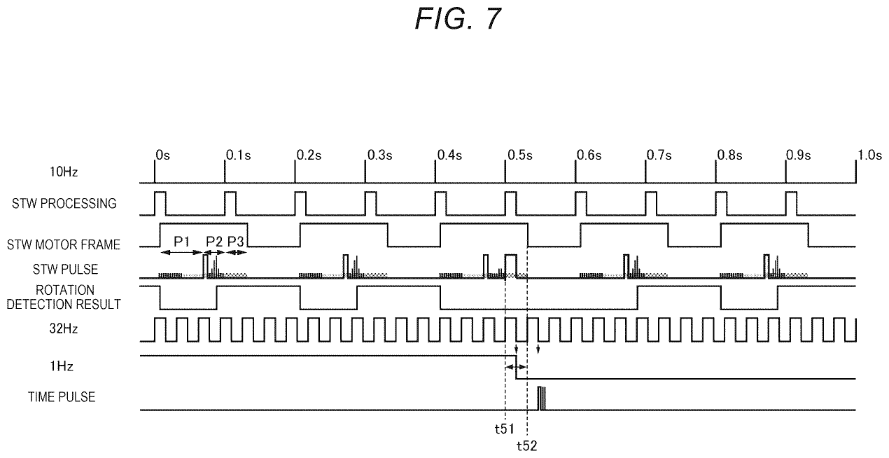

FIG. 7 is a timing chart illustrating a pulse output timing when the time hand movement timing is in the correction pulse output section in the motor frame of the motor 112 and a rotation detection result of the motor 112 is determined to be “non-rotation”. At time t51 in the timing chart in FIG. 7, the correction pulse output section P3 starts, and between time t51 and time t52 when the correction pulse output section P3 ends, the pulse output at 1 Hz changes from high to low. In this case, the rotation detection result remains low from time t51 to time t52. Therefore, the control unit 101 checks in a cycle of 32 Hz until time t52 when the correction pulse output section P3 ends, and outputs a fixed pulse for the motor 108 at a confirmation timing of a first cycle of 32 Hz after time t52 when the correction pulse output section P3 ends.
(4) When the time hand movement timing is immediately before the motor frame of the motor 112, and the time hand movement is performed

Consider a case where the time hand movement timing is immediately before the motor frame of the motor 112, and the time hand movement is performed, for example, a case where the time hand movement timing and a motor frame start timing overlap each other when the control unit 101 checks in the cycle of 32 Hz.
(4-1) When the time hand movement is performed by a fixed pulse method

When the time hand movement timing is immediately before the motor frame of the motor 112, the time hand movement is performed, and the time hand movement is performed by the fixed pulse method, the control unit 101 waits for a pulse output to the motor 112 until a fixed pulse output to the motor 108 ends, and when the fixed pulse output to the motor 108 ends, the control unit 101 outputs a pulse to the motor 112.

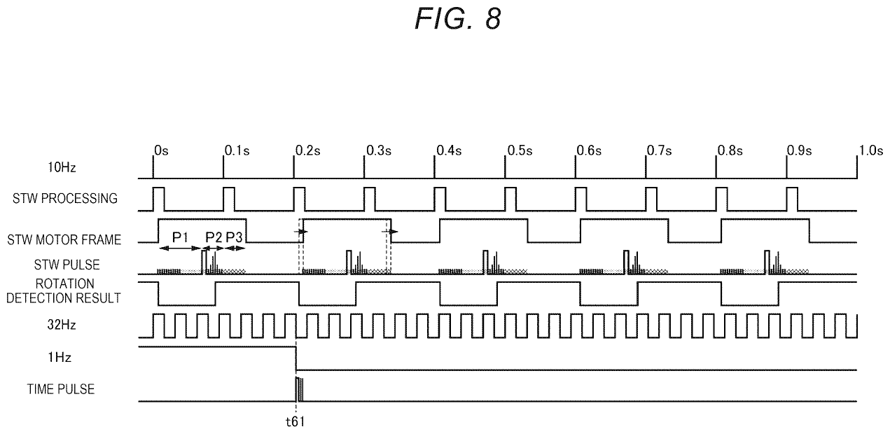

FIG. 8 is a timing chart illustrating a pulse output timing when the time hand movement timing is immediately before the motor frame of the motor 112, and the time hand movement is performed, and the time hand movement is performed by the fixed pulse method. When a pulse output at 1 Hz transitions from high to low at time t61, the control unit 101 starts outputting a fixed pulse to the motor 108. When the fixed pulse output to the motor 108 is completed, the control unit 101 outputs a pulse to the motor 112. That is, the control unit 101 slightly delays a start timing of the motor frame of the motor 112.
(4-2) When the time hand movement is performed by the correction drive method, and a hand movement timing of the stopwatch is in a motor frame of the motor 108

When the time hand movement is performed by the correction drive method and the hand movement timing of the stopwatch is in the motor frame of the motor 108, the control unit 101 waits for a pulse output to the motor 112 until the motor frame of the motor 108 ends, and when the motor frame of the motor 108 ends, outputs a pulse so as to drive the motor 112 by a fixed pulse at the time of a first stopwatch hand movement and drive the motor 112 by the correction drive method at the time of a subsequent stopwatch hand movement.

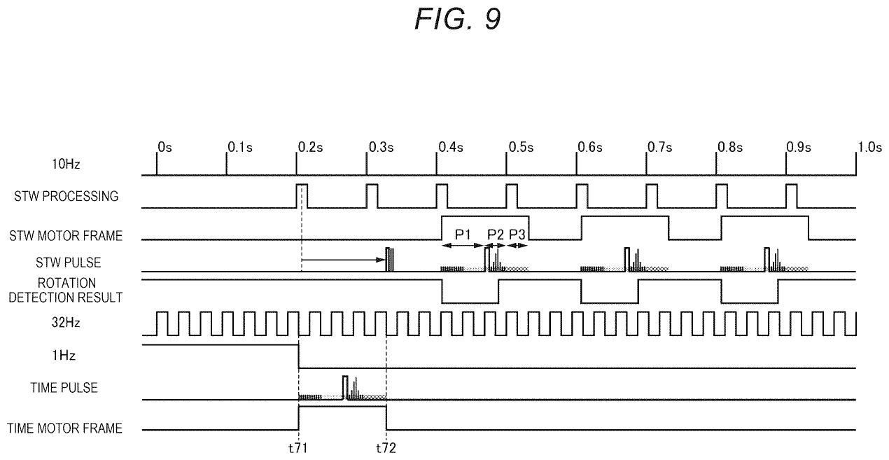

FIG. 9 is a timing chart illustrating a pulse output timing when the time hand movement is performed by the correction drive method and the hand movement timing of the stopwatch is in the motor frame of the motor 108. At time t71 in the timing chart in FIG. 9, the motor frame (time motor frame) of the motor 108 starts, and between time t71 and time t72 when the motor frame of the motor 108 ends, an output of a pulse of STW processing starts, and the hand movement timing of the stopwatch starts. In this case, the control unit 101 does not output a pulse to the motor 112 until time t72 when the motor frame of the motor 108 ends. When the motor frame of the motor 108 ends, the control unit 101 outputs a pulse to drive the motor 112 with a fixed pulse at the time of the first stopwatch hand movement and drive the motor 112 by the correction drive method at the time of the subsequent stopwatch hand movement.

Thus, by adjusting an output timing of the pulse to the motor 108 and an output timing of the pulse to the motor 112 according to the pattern, the control unit 101 achieves low current consumption without causing a voltage drop due to overlapping of the pulses. The control unit 101 can extend a life of the battery 103 of the timepiece 1 or shorten time required for charging when the battery 103 is a secondary battery product by achieving low current consumption without causing a voltage drop due to overlapping of the pulses. By achieving low current consumption without causing a voltage drop due to overlapping of the pulses, the control unit 101 can replace the dial with one having low transmittance when the battery 103 is a secondary battery product, and can improve a sensitivity value.

When detecting a voltage of the battery 103, the control unit 101 may perform detection while avoiding a period in which a correction drive pulse is output to the motor 108 or the motor 112. By detecting the voltage of the battery 103 while avoiding the period in which the correction drive pulse is output to the motor 108 or the motor 112, the control unit 101 can prevent a voltage value of the battery 103 from being detected to be excessively low.

The control unit 101 periodically monitors a user input (for example, a signal from the button 118 or the crown 120), and when a certain standby time (for example, 5 minutes) has elapsed, the control unit 101 may stop power supply to modules unnecessary for a display function of the timepiece, for example, the motor drive circuit 111 and the frequency division circuit 117 related to stopwatch measurement. In this state, since only minimum circuits necessary for the time display function, for example, the control unit 101, the motor drive circuit 107, and the oscillation circuit 116 operate, it is possible to reduce the entire current consumption. When a user input is detected again, the control unit 101 wakes up a stopped circuit and returns the circuit to a previous operation state.

Next, an operation of the control unit 101 will be described.

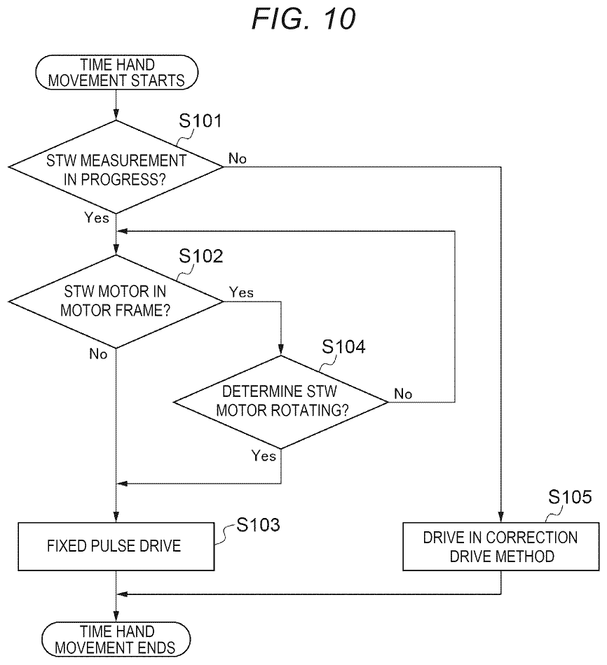

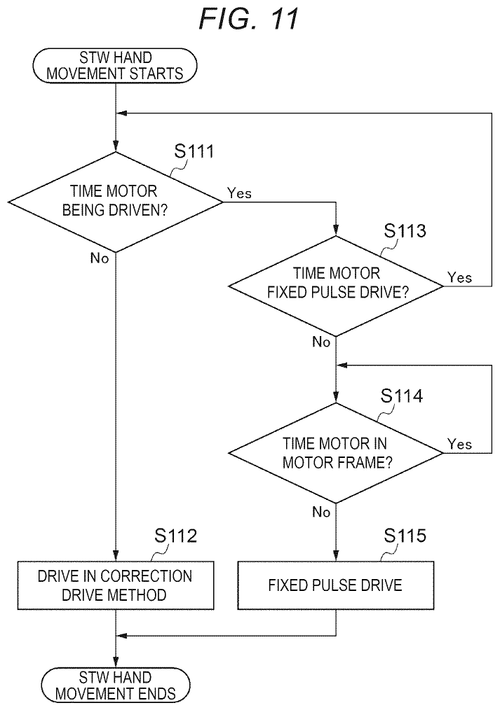

FIGS. 10 and 11 are flowcharts illustrating a flow of control processing of the timepiece 1 executed by the control unit 101. The control processing of the timepiece 1 is performed by the control unit 101 reading a control program of the timepiece 1 from the ROM 123, loading the control program in the RAM 122, and executing the control program.

FIG. 10 is the flowchart illustrating the flow of the control processing of the timepiece 1 executed by the control unit 101 during a time hand movement.

In step S101, the control unit 101 determines whether the stopwatch measurement is in progress. The control unit 101 determines whether the stopwatch measurement is in progress, for example, based on whether a user operates the button 118 to start the stopwatch measurement.

As a result of the determination in step S101, if the stopwatch measurement is in progress (step S101; Yes), the control unit 101 determines whether the motor 112 (STW motor) is in the motor frame in step S102.

As a result of the determination in step S102, if the motor 112 is not in the motor frame (step S102; No), the control unit 101 drives the motor 108 by the fixed pulse method in step S103.

As a result of the determination in step S102, if the motor 112 is in the motor frame (step S102; Yes), the control unit 101 waits until it is determined in step S104 that the motor 112 (STW motor) is rotating. If the motor 112 is not rotating (step S104; No), the control unit 101 returns to determination processing of step S102. If the motor 112 is rotating (step S104; Yes), the control unit 101 drives the motor 108 by the fixed pulse method in step S103.

As a result of the determination in step S101, if the stopwatch measurement is not in progress (step S101; No), the control unit 101 drives the motor 108 in the correction drive method in step S105.

FIG. 11 is the flowchart illustrating the flow of the control processing of the timepiece 1 executed by the control unit 101 during a stopwatch hand movement.

In step S111, the control unit 101 determines whether the motor 108 (time motor) is being driven. The control unit 101 determines whether the motor 108 (time motor) is being driven based on whether a switching timing of the pulse state of 1 Hz has arrived.

As a result of the determination in step S111, if the motor 108 (time motor) is not being driven (step S111; No), the control unit 101 drives the motor 112 (STW motor) in the correction drive method in step S112.

As a result of the determination in step S111, if the motor 108 (time motor) is being driven (step S111; Yes), the control unit 101 determines whether the motor 108 (time motor) is driven in the fixed pulse method in step S113.

If the motor 108 (time motor) is driven in the fixed pulse method (step S113; Yes), the control unit 101 returns to the determination of step S111. If the motor 108 (time motor) is not driven in the fixed pulse method (step S113; No), the control unit 101 determines whether the motor 108 (time motor) is in the motor frame of the correction drive method in step S114.

If the motor 108 (time motor) is in the motor frame of the correction drive method (step S114; Yes), the control unit 101 waits until the motor 108 (time motor) is no longer in the motor frame of the correction drive method. If the motor 108 (time motor) is not in the motor frame of the correction drive method (step S114; No), the control unit 101 drives the motor 112 (STW motor) in the fixed pulse method in step S115.

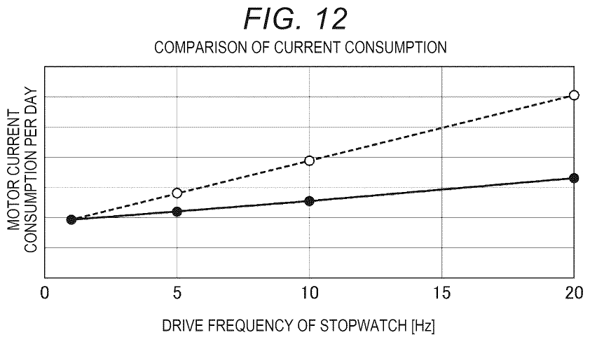

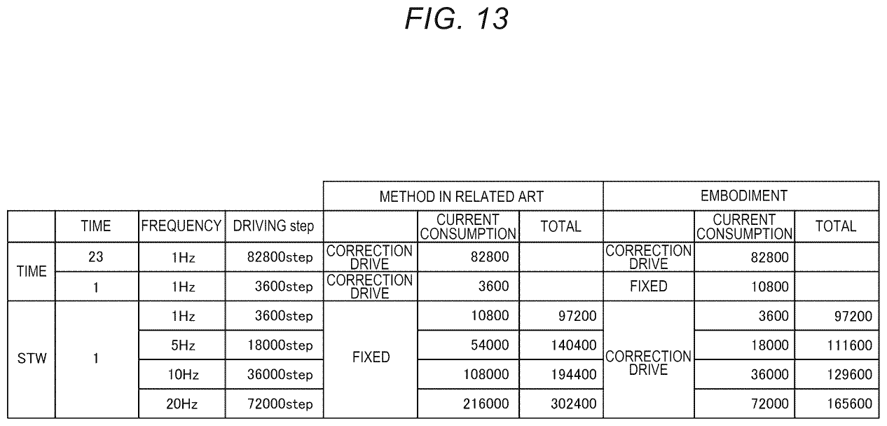

Effects of the present embodiment will be described. Here, a case where a stopwatch measurement function is used for one hour per day when current consumption of the correction drive method: current consumption of the fixed pulse method=1:3 will be described. FIG. 12 is a graph illustrating the effect of the present embodiment. FIG. 13 is a table illustrating the effect of the present embodiment.

A dashed line in the graph of FIG. 12 indicates current consumption in an example in the related art when a timepiece motor is set to correction drive and a stopwatch motor is set to the fixed pulse method, and a solid line indicates current consumption in the present embodiment when a timepiece motor (motor 108) is set to the fixed pulse method and a stopwatch motor (motor 112) is set to correction drive. FIG. 13 is a table comparing specific values of current consumption in one day.

As illustrated in FIGS. 12 and 13, it can be seen that the current consumption is lower when the timepiece motor (motor 108) is set to the fixed pulse method and the stopwatch motor (motor 112) is set to the correction drive method. It can be seen that the higher a drive frequency of the stopwatch, the greater a difference in current consumption between the two.

The embodiment of the present disclosure has been described above in detail with reference to the accompanying drawings, but the technical scope of the present disclosure is not limited to such examples. It is clear that a person with ordinary knowledge in the technical field of the present disclosure can conceive of various changes and modifications within the scope of the technical ideas described in the claims, and it is understood that these changes and modifications also naturally fall within the technical scope of the present disclosure.

The effects described in the above embodiment are illustrative or exemplary, and are not limited to those described in the above embodiment. That is, in addition to the effects described in the above embodiment or instead of the effects described in the above embodiment, the technology according to the present disclosure can achieve other effects that are obvious to those skilled in the art of the present disclosure from the description in the above embodiment. The present disclosure may also be applied to a program product.

Regarding the above embodiment, the following appendixes are further disclosed.

### Appendix 1

A timepiece including:
a battery;
a time display function;
a measurement display function different from the time display function;
a first motor configured to operate with the electric power of the battery, the first motor corresponding to the time display function;
a second motor configured to operate with the electric power of the battery, the second motor corresponding to the measurement display function; and
a control unit configured to control operations of the first motor and the second motor, in which
the control unit
when the measurement display function is not in operation, causes the first motor to operate in a correction drive method of outputting a correction drive pulse for driving the motor in accordance with determination of presence or absence of rotation of the motor in a hand movement cycle of 1 Hz, and
when the time display function and the measurement display function are both in operation,
   causes the first motor to operate in a fixed pulse method of outputting a predetermined pulse in the hand movement cycle of 1 Hz,
   causes the second motor to operate in the correction drive method in a hand movement cycle shorter than 1 Hz, and
   adjusts an output timing so that timings of pulse for driving the first motor and the second motor do not overlap.

### Appendix 2

The timepiece according to Appendix 1, in which
in a case where a hand movement timing of the time display function is in a period for outputting the correction drive pulse in the correction drive method, when determining that the second motor is rotating, the control unit waits for an output of a pulse in the fixed pulse method until a rotation detection flag of the second motor is set.

### Appendix 3

The timepiece according to Appendix 1 or 2, in which
in a case where a hand movement timing of the time display function is in a period for outputting the correction drive pulse in the correction drive method, when determining that the second motor is not rotating, the control unit waits for an output of a pulse in the fixed pulse method until the period ends.

### Appendix 4

The timepiece according to any one of Appendixes 1 to 3, in which
when a hand movement timing of the time display function is in a period for outputting the correction drive pulse in the correction drive method, the control unit waits for start of the period for outputting the correction drive pulse until an output of a pulse in the fixed pulse method is completed.

### Appendix 5

The timepiece according to any one of Appendixes 1 to 4, in which
the control unit detects a voltage of the battery while avoiding a period in which the correction drive pulse is output.

### Appendix 6

A control method for a timepiece including a battery, a time display function, a measurement display function different from the time display function, a first motor configured to operate with the electric power of the battery, the first motor corresponding to the time display function, and a second motor configured to operate with the electric power of the battery, the second motor corresponding to the measurement display function, the control method including:
by a processor,
when the measurement display function is not in operation, causing the first motor to operate in a correction drive method of outputting a correction drive pulse for driving the motor in accordance with determination of presence or absence of rotation of the motor in a hand movement cycle of 1 Hz; and
when the time display function and the measurement display function are both in operation,
causing the first motor to operate in a fixed pulse method of outputting a predetermined pulse in the hand movement cycle of 1 Hz,
causing the second motor to operate in the correction drive method in a hand movement cycle shorter than 1 Hz, and
adjusting an output timing so that timings of pulse for driving the first motor and the second motor do not overlap.

### Appendix 7

A control program for a timepiece including a battery, a time display function, a measurement display function different from the time display function, a first motor configured to operate with the electric power of the battery, the first motor corresponding to the time display function, and a second motor configured to operate with the electric power of the battery, the second motor corresponding to the measurement display function, the control program causing a computer to execute processing of:
when the measurement display function is not in operation, causing the first motor to operate in a correction drive method of outputting a correction drive pulse for driving the motor in accordance with determination of presence or absence of rotation of the motor in a hand movement cycle of 1 Hz; and
when the time display function and the measurement display function are both in operation,
causing the first motor to operate in a fixed pulse method of outputting a predetermined pulse in the hand movement cycle of 1 Hz,
causing the second motor to operate in the correction drive method in a hand movement cycle shorter than 1 Hz, and
adjusting an output timing so that timings of pulse for driving the first motor and the second motor do not overlap.

What is claimed is:

1. A timepiece comprising:
a battery;
a time display function;
a measurement display function different from the time display function;
a first motor configured to operate with the electric power of the battery, the first motor corresponding to the time display function;
a second motor configured to operate with the electric power of the battery, the second motor corresponding to the measurement display function; and
a control unit configured to control operations of the first motor and the second motor, wherein
the control unit
when the measurement display function is not in operation, causes the first motor to operate in a correction drive method of outputting a correction drive pulse for driving the motor in accordance with determination of presence or absence of rotation of the motor in a hand movement cycle of 1 Hz, and
when the time display function and the measurement display function are both in operation,
causes the first motor to operate in a fixed pulse method of outputting a predetermined pulse in the hand movement cycle of 1 Hz,
causes the second motor to operate in the correction drive method in a hand movement cycle shorter than 1 Hz, and
adjusts an output timing so that timings of pulse for driving the first motor and the second motor do not overlap.

2. The timepiece according to claim 1, wherein
in a case where a hand movement timing of the time display function is in a period for outputting the correction drive pulse in the correction drive method, when determining that the second motor is rotating, the control unit waits for an output of a pulse in the fixed pulse method until a rotation detection flag of the second motor is set.

3. The timepiece according to claim 1, wherein
in a case where a hand movement timing of the time display function is in a period for outputting the correction drive pulse in the correction drive method, when determining that the second motor is not rotating, the control unit waits for an output of a pulse in the fixed pulse method until the period ends.

4. The timepiece according to claim 1, wherein
when a hand movement timing of the time display function is in a period for outputting the correction drive pulse in the correction drive method, the control unit waits for start of the period for outputting the correction drive pulse until an output of a pulse in the fixed pulse method is completed.

5. The timepiece according to claim 1, wherein
the control unit detects a voltage of the battery while avoiding a period in which the correction drive pulse is output.

6. A control method for a timepiece including a battery, a time display function, a measurement display function different from the time display function, a first motor configured to operate with the electric power of the battery, the first motor corresponding to the time display function, and a second motor configured to operate with the electric power of the battery, the second motor corresponding to the measurement display function, the control method comprising:
by a processor,
when the measurement display function is not in operation, causing the first motor to operate in a correction drive method of outputting a correction drive pulse for driving the motor in accordance with determination of presence or absence of rotation of the motor in a hand movement cycle of 1 Hz; and
when the time display function and the measurement display function are both in operation,
causing the first motor to operate in a fixed pulse method of outputting a predetermined pulse in the hand movement cycle of 1 Hz,
causing the second motor to operate in the correction drive method in a hand movement cycle shorter than 1 Hz, and
adjusting an output timing so that timings of pulse for driving the first motor and the second motor do not overlap.

7. A control program for a timepiece including a battery, a time display function, a measurement display function different from the time display function, a first motor configured to operate with the electric power of the battery, the first motor corresponding to the time display function, and a second motor configured to operate with the electric power of the battery, the second motor corresponding to the measurement display function, the control program causing a computer to execute processing of:
when the measurement display function is not in operation, causing the first motor to operate in a correction drive method of outputting a correction drive pulse for driving the motor in accordance with determination of presence or absence of rotation of the motor in a hand movement cycle of 1 Hz; and
when the time display function and the measurement display function are both in operation,
causing the first motor to operate in a fixed pulse method of outputting a predetermined pulse in the hand movement cycle of 1 Hz,
causing the second motor to operate in the correction drive method in a hand movement cycle shorter than 1 Hz, and
adjusting an output timing so that timings of pulse for driving the first motor and the second motor do not overlap.
